(19) United States
(12) Patent Application Publication
(10) Pub. No.: US 2002/0162235 A1
(43) Pub. Date: Nov. 7, 2002

(54) Tilt sensor or an automatic leveling device

(76) Inventor: Joseph F. Rando, Los Altos Hills, CA (US)

Correspondence Address: Thomas M. Freiburger, 25th Floor, 650 California Street, San Francisco, CA, 94108, US

(21) Appl. No.: 09/731,888

(22) Filed: Dec. 7, 2000

(51) Int. Cl. G01C 9/06

(52) U.S. Cl. 33/366.16; 33/366.23

(57) ABSTRACT

A tilt sensor for use in an automatic leveling device includes a level vial with a level bubble, the vial including a metal base member. The metal base has provisions for mounting the sensor device to an instrument or object to be leveled, and optical as well as capacitive sensing arrangements are disclosed for sensing the position of the level bubble and providing a signal to be used by a motor that brings the instrument or object to level.

### BACKGROUND OF THE INVENTION

The present invention relates to measuring instrumentation, and more specifically to providing electronic tilt information relative to gravity by sensing a bubble position for the purpose of controlling a self-leveling platform.

In the invention an electrical signal is produced generally proportional to the tilt angle depending on bubble position. The platform is used in precision surveying instruments.

In the prior art a conventional level vial of glass or plastic contains a low viscosity liquid such as turpentine in a tube. The liquid vessel in most cases is a cylindrical tube with a slight curvature in the vertical plane. As the vessel is tilted in this vertical plane the bubble moves along the cylinder. Automatic detectors in the prior art sensed the bubble location and thus the tilt optically or capacitively. Such methods are described in U.S. Pat. Nos. 4,625,423, 4,956,922, 5,101,570 and 5,953,116. The methods included focusing and refracting the light as well as absorbing with an opaque fluid. In other prior art the bubble is located using the absence of capacity due to the bubble.

### SUMMARY OF THE INVENTION

The basic principle controlling the bubble location can be described in terms of the liquid seeking the lowest potential energy. Thus a horizontally held under-filled tube with a curvature in the vertical plane will have a bubble in the center. As the tube is tilted within the vertical plane, and as the liquid seeks the lowest energy level, the bubble will move along the level vial.

In most precision applications of electronic level vials, the vial is mounted to a metal frame. The glass-metal interface is difficult to control over a large temperature range because of the very different coefficients of linear expansion of glass and metal. By using a metal member as part of the liquid container, this mounting problem is eliminated. An added advantage of a metal vessel is the improved thermal stability due to the high thermal conductivity of the metal. In addition, the use of a metal member is less expensive than making a precision glass tube.

In the metal vial of the invention the vertical curvature required for the bubble motion is fabricated in the metal forming process. The liquid container is closed using a plastic member which allows for sensing of the bubble location, e.g. optical sensing. This use of a metal vial or at least a metal base member ensures that in all environments the temperature gradient across the chamber is small. The plastic member of the container may be designed to do more than just contain the fluid. Provision for mounting the LED light source and the detectors can be incorporated into the plastic member or container. In addition the plastic surfaces used as optical windows of the housing can be clear while other surfaces can be rough for scattering unwanted light. An alternate sensing method would use electrodes on the plastic member or container to measure the bubble location using a capacitance measurement. Response time of the system is determined by such elements as the bubble curvature, bubble size, viscosity of the liquid, proximity of the container wall and by controlling the cross sectional area of the container. For example, a bubble in a container with a shallow bottom will move more slowly than a bubble in a deep container.

Another method of providing the needed bubble motion with tilt angle uses the cross section of the vial, with no vertical curvature. In this case, the upper surface containing the liquid is flat and the cross section is wide in the center and narrow on the ends. Since the volume of the bubble is a constant, reducing the width of the channel at the ends lowers the bubble's center of gravity. Therefore, the locus of the center of gravity of the bubble is an arc in the vertical plane. This is similar to the locus of the center of gravity for the normal curved tubular level vial.

It is thus an object of the invention to improve construction, thermal insensitivity and reliability in a level bubble vessel in which the bubble's position is automatically sensed. These and other objects, advantages and features of the invention will be apparent from the following description of a preferred embodiment, considered along with the accompanying drawings.

### DESCRIPTION OF THE DRAWINGS

FIG. 1 is an elevation view of a tilt sensor of the invention.

FIG. 2 is a bottom view of the tilt sensor of FIG. 1.

FIG. 3 is a transverse sectional elevation view of the sensor of FIG. 1, seen along the line 3-3 in FIG. 2, with a bubble in the center.

FIG. 4 is a transverse section view similar to FIG. 3 but with a bubble at the end.

FIG. 5 is a longitudinal section view in elevation of the sensor of FIG. 1.

FIGS. 6A, 6B and 6C are similar bottom views of the sensor of FIG. 1, showing bubble motion.

FIG. 7 is a schematic circuit diagram showing conversion of a signal from the sensor to the motor drive into the case of optical detection of the bubble location.

FIG. 8 is a bottom plan view of a tilt sensor using variation of the vessel channel width to control the bubble motion with tilt.

FIG. 9 is a transverse sectional elevation view of the tilt sensor of FIG. 8 showing bubble sensing as seen along the line 9-9 in FIG. 8.

FIG. 10 is a schematic bottom plan view of a tilt sensor with electrodes used to sense the bubble position.

FIG. 11 is a sectional elevation view of the sensor of FIG. 10 as seen along the line 11-11 in FIG. 10.

FIG. 12 is a bottom view of a tilt sensor using capacitive sensing of the bubble position and showing the bubble tilt control of FIG. 8.

FIG. 13 is a transverse sectional elevation view of the tilt sensor of FIG. 12.

FIG. 14 is a schematic circuit diagram showing the conversion of the sensor signal to motor control.

### DESCRIPTION OF PREFERRED EMBODIMENTS

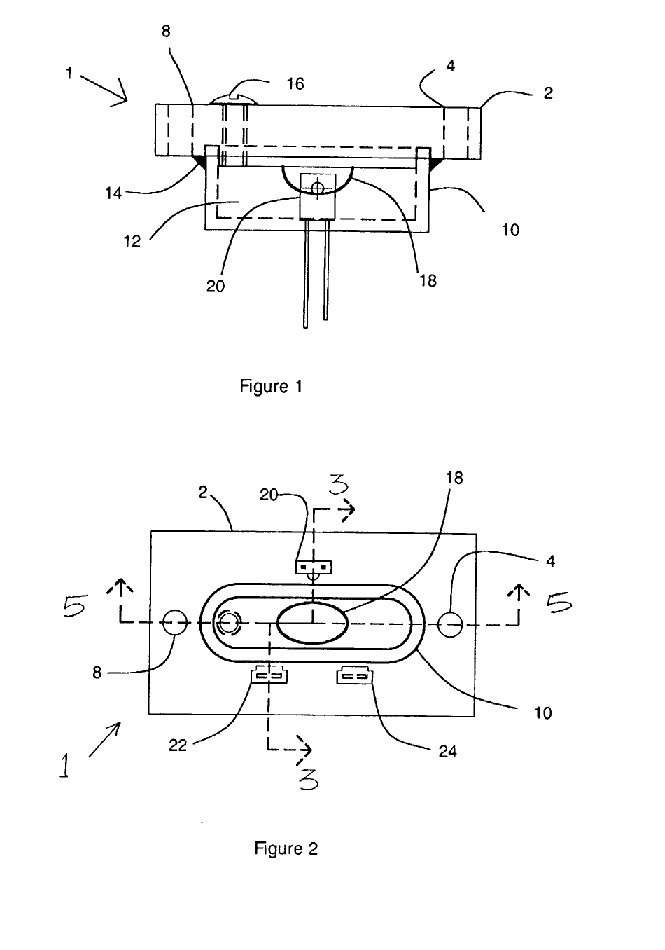

A preferred embodiment is shown generally as 1 in FIG. 1. An aluminum base 2 has mounting holes 4 and 8. A liquid 12 is contained by a clear plastic vessel member 10 which is held in place by an adhesive 14. A screw 16 seals the vessel. Adhesive on the screw, not shown, can be used to assist the sealing. A bubble 18 is formed because the vessel is not completely filled. A light emitting diode is shown at 20, positioned to shine light through the vessel 10, generally horizontally.

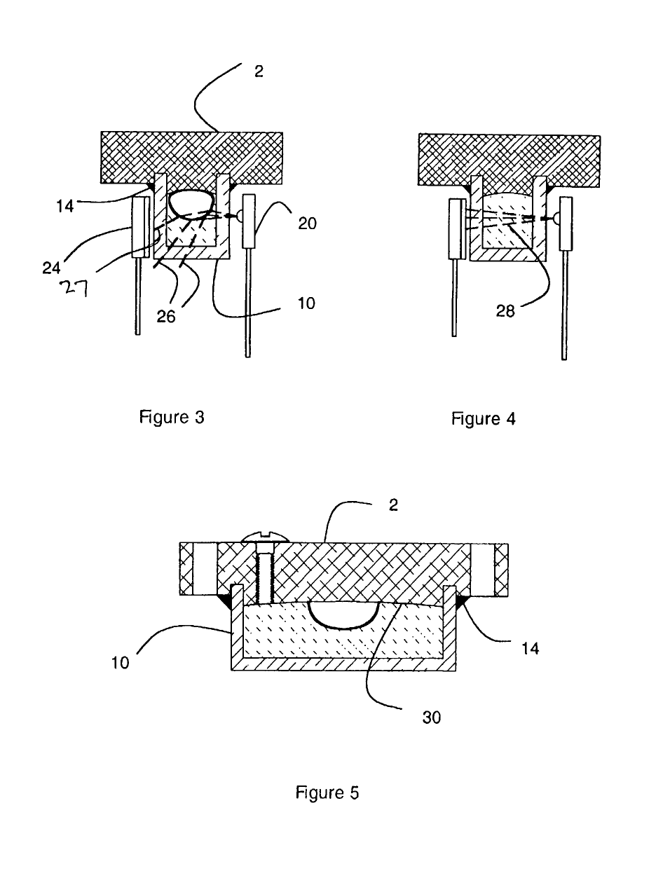

A bottom view of the assembly 1 is shown in FIG. 2. LED 20 and photo detectors 22 and 24 are shown in the figure, oriented for horizontal travel of the LED light through the liquid. FIG. 3 is a section view showing the light path when a buble is located in the center of the vessel as in FIG. 2. Most of the light 26 is reflected by total internal reflection so it does not reach the detectors 22 and 24. A small amount of light 27 is refracted through the bubble and reaches the detectors.

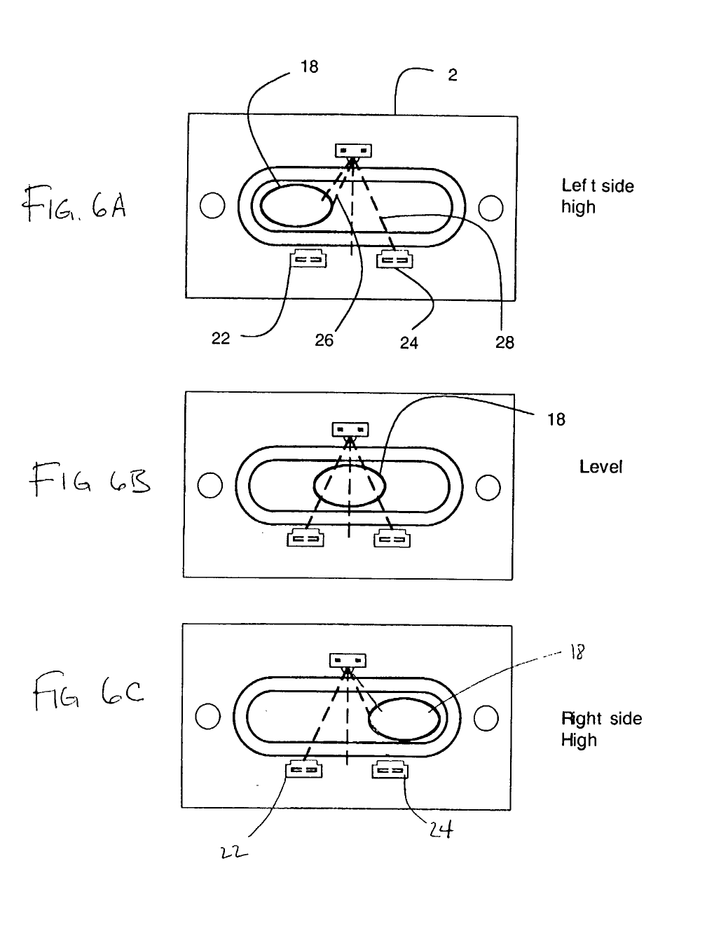

The section view of FIG. 4 shows light rays 28 reaching one of the detectors in the absence of the bubble in the light path. FIG. 5 is a section view showing a curvature 30 on the roof of the vessel, which controls the motion of the bubble with tilt. This direct liquid contact with the metal base providing the roof or ceiling is an important feature of the invention allowing for high repeatability because of the direct contact to the frame of the platform, high thermal stability, and the thermal conductivity of the aluminum base.

FIGS. 6A-6C show how the light rays are directed by the position of the bubble 18. When the left side of the level sensor is high, the bubble prevents most of the light from reaching the detector 22. Most of the light is reflected by total internal reflection at the bubble liquid interface. On the other hand, the light rays 28 do reach the detector 24. When the bubble is in the center the light reaches the detectors 22 and 24 with equal intensity, as in FIG. 6B. When the right side of the level sensor is high more light reaches detector 22 and little reaches the detector 24, as in FIG. 6C.

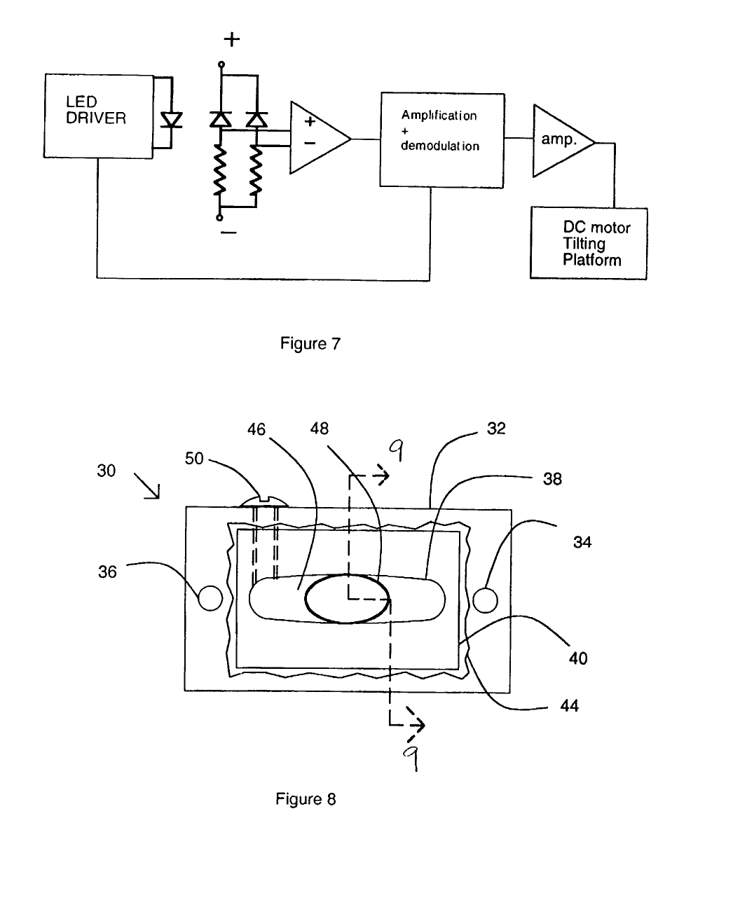

FIG. 7 is a block diagram indicating a circuit and showing how the difference of the detector signal is amplified to drive a motor which tilts a platform (motor and platform represented by a block). To avoid oscillation, a phase shift network may also be incorporated in the amplification path.

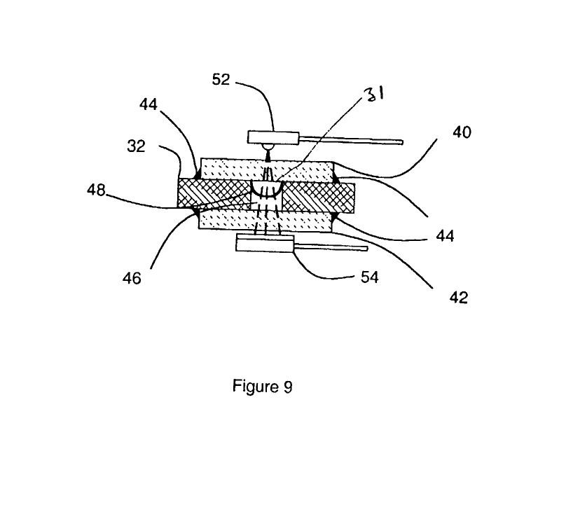

FIGS. 8 and 9 show the bottom of a level sensor 30 having no vertical curve in the upper surface of its liquid vessel chamber. A base 32 has mounting holes 34 and 36. Top window 40 and bottom window 42 (42 not shown in this figure) are sealed to the sensor base 32 with an adhesive 44. A channel 38 whose side walls are elliptically curved determines the tilt sensitivity of a bubble 48. The channel is slightly under-filled with a liquid 46. A seal screw 50, which may be in the side as shown, is used to seal the channel. As noted above, due to the elliptical walls and the maximum width at the center, the bubble 48 experiences least bouyancy pressure in the center when level and thus is stable and localized in the centered, leveled position despite the flat upper vessel surface.

FIG. 9 is a section view of the tilt sensor of FIG. 8. An LED light source 52 shines light down through the channel 46 and is detected by a photo detector (array) 54 at the underside (the LED 52 and the detector 54 are not shown in FIG. 8). The refraction of the bubble steers the beam to the detectors as would a negative lens. This principle is described in prior patents including some of those listed above.

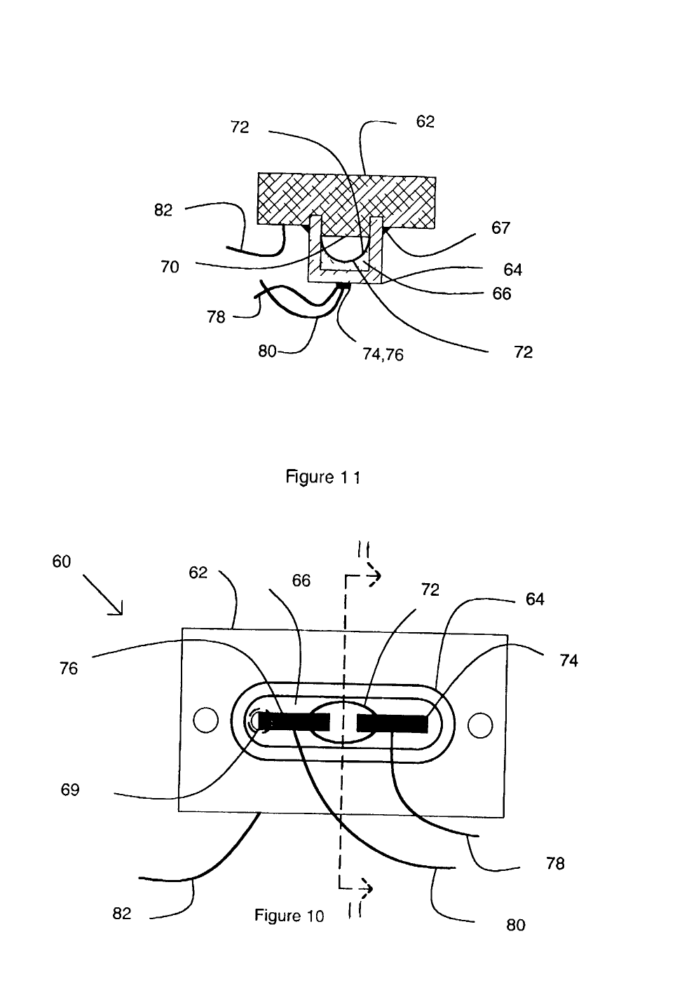

In an alternate preferred embodiment of the invention, the bubble location is sensed using the capacitance of the liquid or the absence of capacitance via the bubble as opposed to the optical sensing described above. The bottom plan view of FIG. 10 and the section view of FIG. 11 show a tilt sensor generally designated as 60. A base 62 and attached plastic vessel member 64 produce a channel for a liquid 66. The channel is sealed with an adhesive 67 and filled preferably through a tapped hole indicated at 69. A vessel ceiling surface 70 has a vertical curvature which controls the bubble motion with tilt as described above and shown in FIG. 5. A bubble 72 is formed by underfilling the channel. Electrodes 74 and 76 on the plastic vessel member 64 are used to measure the bubble location. Wires 78 and 80 are attached to the electrodes 74 and 76 for measurement along with a ground wire 82 connected to the metal base.

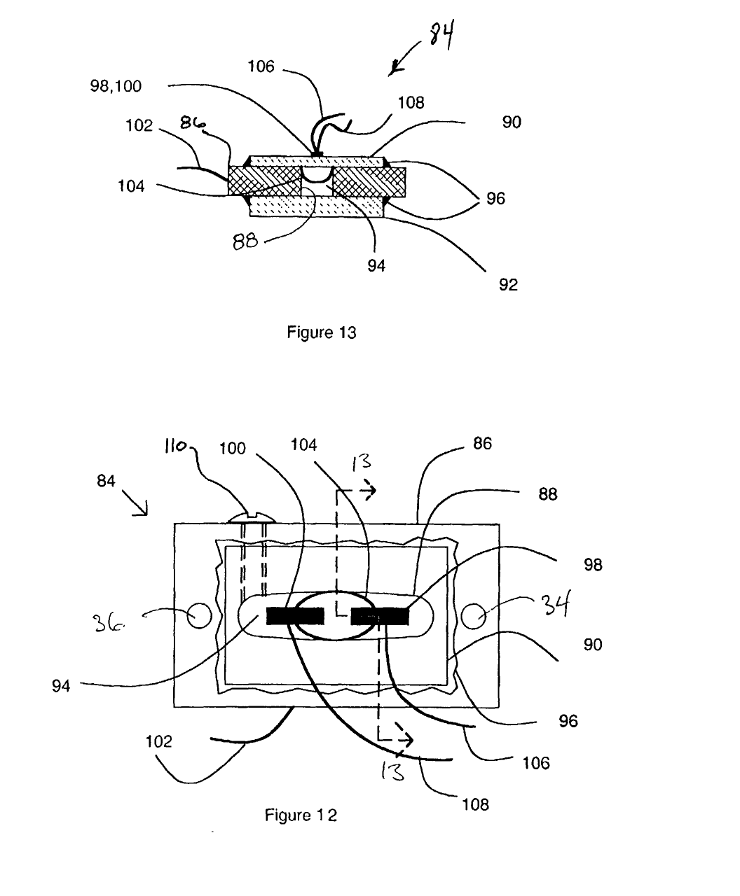

In an alternate preferred embodiment of capacitive sensing, the bubble controlling curvature is in the vessel or channel wall shape as was done in FIGS. 8 and 9 and is shown anew in the bottom plan view of FIG. 12 and in the section view of FIG. 13. The tilt sensor is shown generally by 84. Its metal base 86 has an elliptical channel 88 which controls the bubble motion with tilt. Dielectric covers 90 and 92 complete the channel's containment of a fluid 94. The covers are sealed with an adhesive 96. Electrodes 98 and 100 are used to sense the position of the bubble 104 via the capacitance measurement, via wires 106, 108 and ground wire 102. A seal screw 110 is used to fill the channel with liquid.

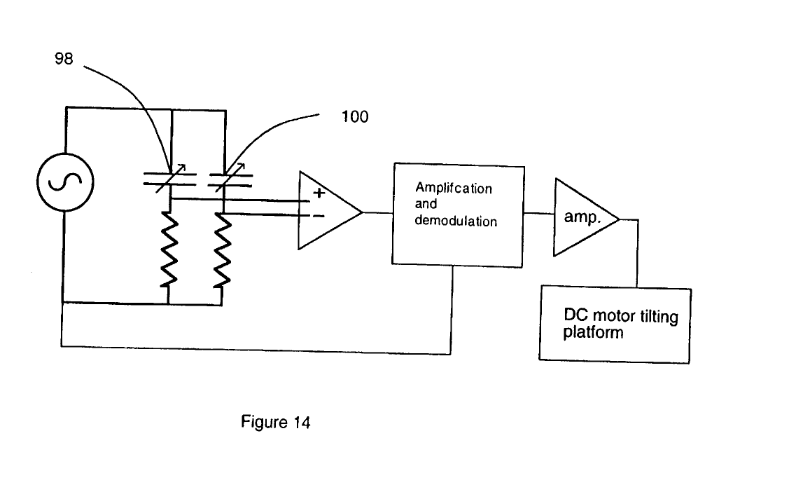

FIG. 14 is similar to FIG. 7, being a schematic circuit diagram indicating generation of a signal to be fed to a DC motor tilting platform. As in FIG. 7, the motor and platform are not shown, only indicated by a block. The circuit of FIG. 14 shows use of capacitance bubble sensing, for embodiments such as shown in FIGS. 10-13. The electrodes 98 and 100 from the sensor shown in FIGS. 12 and 13 are indicated in FIG. 14. When the bubble is closer to the first electrode than the second, less current flows through the first series resistor because of the high AC impedance. The AC difference voltage at the input of the amplifier is, therefore, proportional to bubble location.

The above described preferred embodiments are intended to illustrate the principles of the invention, but not to limit its scope. Other embodiments and variations to this preferred embodiment will be apparent to those skilled in the art and may be made without departing from the spirit and scope of the invention as defined in the following claims.

I claim:

1. An apparatus used for sensing tilt of an object electronically, comprising:
a vessel comprising a metal base with means for mounting the metal base on the object, and including at least one plastic member secured in sealed relationship to the metal base to form the vessel,
a liquid contained in the vessel, but not completely filling the vessel, such that a bubble resides in the vessel, the bubble being movable in a longitudinal direction of the vessel with tilt of the object,
a bubble motion control cross section formed by the shape of the vessel, such that the bubble tends to remain localized and tends to remain at a position indicating level when the object is level, and
bubble sensing means for sensing the position of the bubble in the longitudinal direction, to provide a signal to be used in automatically leveling the device.

2. The apparatus of claim 1, wherein in the bubble sensing means comprises a pair of electrodes positioned on the vessel such that the electrodes sense capacitance in the vessel, which varies with bubble postion.

3. The apparatus of claim 1, wherein the bubble sensing means comprises an optical sensor, with a light source at one side of the exterior of the vessel and at least two photo detectors at an opposite side of the exterior of the vessel, positioned to receive light from the light source, the received light being affected by the positon of the bubble.

4. The apparatus of claim 1, wherein the vessel comprises a channel of substantially rectangular cross section with a vertical curvature on the upper surface of the vessel to aid in bubble motion with tilt.

5. The apparatus of claim 4, wherein the bubble sensing means comprises a pair of electrodes positioned on the vessel such that the electrodes sense capacitance in the vessel, which varies with bubble position.

6. The apparatus of claim 1, wherein the vessel comprises a channel of generally rectangular cross section but having curved walls which vary the cross section along the longitudinal direction such that the vessel is widest in the longitudinal center to provide localization of the bubble and to aid to bubble motion with tilt.

7. The apparatus of claim 6, wherein the bubble sensing means comprises a pair of electrodes positioned on the vessel such that the electrodes sense capacitance in the vessel, which varies with bubble position.

8. The apparatus of claim 6, wherein the bubble sensing means comprises an optical sensor with a light source at one side of the exterior of the vessel and at least two photo detectors at an opposite side of the exterior of the vessel, positioned to receive light form the light source, the received light being affected by the position of the bubble.

9. The apparatus of claim 1, further including a sealable fill hole for placing the liquid in the vessel.

10. The apparatus of claim 1, wherein the bubble sensing means comprises an optical sensor, with a light source on one side of the vessel and sensors positioned on an opposite side, the sensors each being positioned to receive light horizontally through the vessel when the bubble is not between a sensor and the light source, but such that most light is reflected away from the sensor when the bubble is between the sensor and the light source.

11. A method for sensing tilt of an object electronically, comprising:
providing a metal base for a tilt sensor,
securing at least one plastic member to the metal base in sealed relationship so as to form an internal vessel capable of holding a liquid,
adding a liquid to the vessel, such that the vessel is nearly filled but leaving a bubble within the vessel, then sealing the vessel closed,
the metal base to a metal portion of an object whose condition with respect to level is to be sensed, such that when the object is level the bubble within the vessel is located substantially at a position indicating level within a longitudinal path within which the bubble can move with tilt of the object and of the vessel, and
sensing the position of the bubble within the vessel electronically, and generating a signal in accordance with the position of the bubble useful in an electrically operated leveling device for restoring the object to level.

12. The method of claim 11, wherein the step of sensing the position of the bubble comprises directing light from a light source through the plastic member of the vessel and across the bubble positon indicating level, and detecting characteristics of the light passing through the vessel at an opposite side of the vessel, using photo detectors, to generate said signal.

13. The method of claim 11, wherein the step of sensing the position of the bubble comprises measuring capacitance in the vessel using a pair of opposed electrodes which produce a signal corresponding to the position of the bubble.
